(19) United States
(12) Patent Application Publication
(10) Pub. No.: US 2012/0136678 A1
(43) Pub. Date: May 31, 2012

(54) System of Managing Healthcare Information and its Communication and Centralized Searching of Non-Centralized Data to Allow for Patient Control, Choice, and Empowerment

(76) Inventor: Joseph Steinberg, Teaneck, NJ (US)

(21) Appl. No.: 13/298,275

(22) Filed: Nov. 16, 2011

Related U.S. Application Data
(60) Provisional application No. 61/458,030, filed on Nov. 16, 2010.

(51) Int. Cl. G06Q 50/24; G06Q 30/02

(52) U.S. Cl. 705/3

(57) ABSTRACT

A system, method, and computer code which when executed provides centralized searching of non-centralized data, as well a patient-centric healthcare information communication system that allows for decentralized medical records, team collaboration between providers utilizing different medical records systems, and interpretation of medical tests by remote patient-selected providers.

This patent filing claims priority based on the provisional patent entitled “System of Centralized Searching of Non-Centralized Data and Improving System of Managing Healthcare Information Communication to Allow for Patient Control, Choice, and Empowerment” filed on Nov. 16, 2010 with the ID No. 61/458,030 and the filing “System of Managing Healthcare Information Communication to Allow for Patient Control, Choice, and Empowerment” filed on Aug. 9, 2010 with Application No. 61/401,196 and included and incorporated by reference as part of the aforementioned November provisional patent filing.

### BACKGROUND OF THE INVENTION

As the world undergoes the digitalization (i.e., the conversation from paper and film and other hardcopy formats into electronic formats), of “medical records” or “medical information” (terms which I use in this document to include any and all information related to healthcare—including, but not limited to, medical, dental, chiropractic, homeopathic and alternative, test results (such as imaging studies, lab results on body fluids, etc.), pharmaceutical, psychical/occupational/therapy and other treatment) numerous different Electronic Medical Records (EMR) and related systems have been deployed at providers (including, but not limited to, doctors' offices, hospitals, dental facilities, insurance companies, laboratories, drugstores, clinics, imaging and testing facilities, medical centers, and numerous other entities involved in healthcare). These EMR and related systems are typically provider-focused; some do not provide any direct patient access, and those that do are typically still provider-centric, and often deliver patient access to only a small subset of information contained within the system—for example, allowing patients to check financial-information (account balances, bills, insurance claims, etc.) but not to access their own detailed medical records.

Medical-records management systems designed for patients—that is, for people who, during a specific usage of a system are acting from the vantage point of receiving healthcare offerings rather than acting from a vantage point of providing them (although clearly physicians are also at times patients of other physicians)—have also not achieved widespread acceptance. (Patients also includes the guardians, or assistants, of others receiving medical care—a parent for a child, or an adult for an elderly parent with dementia, for example.) The requirement by online medical record management services that users store medical records online—in repositories that are, of course, ultimately possessed by outside parties that host the data—has been disconcerting enough for many people from a security and privacy standpoint to discourage the systems' wide adoption. Likewise, systems that store medical information on users' computers have been found inadequate as records are often not available at times when users need them—for example, if a user arrives at a specialist-doctor appointment and finds that records that were supposed to have been sent from her general practitioner were never received by the specialist, if the records are stored in the user's home computer the user will likely be unable to access the records while in the doctor's office and may need to reschedule her appointment.

As a result, obtaining and managing medical records remains a cumbersome process for patients. People must often call doctors' offices and visit them in person to obtain copies of records, go to medical imaging facilities to obtain copies of X-Rays, MRIs, etc., confirm delivery of records, or otherwise dedicate significant effort to this task. Providers may also charge patients for copies of records to compensate for the time that they or their staffs spend producing them. While talk of inter-connected medical records sharing systems has gone on for quite some time, to date such automated communication is essentially non-existent outside of affiliated entities or parties utilizing identical EMR systems. Even within the entities, control over the data belongs to the providers—patients cannot login and control personal information about their own health. Furthermore, some people may not wish to ever have full sharing of their medical information between all parties—either for security, privacy, or other reasons; many folks may wish to have better control over who gets to see specifically which medical information about them.

Providing medical records, is, therefore, also cumbersome, inefficient, and expensive for providers as well. Since the law in most American jurisdictions and other Western nations requires medical providers to provide such records to patients—and the fees charges to patients often do not account for the true total cost of providing them—it costs them financially as well. Time and money is also wasted looking for records that may have been moved, transitioned to archives, or non-existent to begin with (e.g., a patient thinks MRI results were sent to Dr. X when they were sent to Dr. Y). The current invention will seek to correct this waste as well.

Today, even with the most sophisticated EMRs deployed, a patient who wants to send medical records from a doctor to another unrelated doctor often has to manually obtain the records and manually deliver them—especially if images are involved. Different EMRs do not cross communicate, and records not yet stored in EMRs are often not available electronically. Providers have been wary to provide easier access to records due to concerns about HIPAA protections etc; as such, the current process remains inefficient and error-prone.

Another problem people face today is that, after some period of time, providers may erase medical records or store them in some difficult-to-access archive. Since old medical records can often be very useful in treating a condition, this is problematic. For example, if a patient is complaining of headaches and had an MRI of her brain 10 years earlier it might be useful to see that MRI when attempting to diagnose and treat now so that it can be compared with any current MRIs or findings to look for any changes. It is useful to provide an expiration date on any or all medical records so that patients can see when archiving may occur and take action prior to those occurrences to obtain either a copy of the records or to have them sent to another provider. A patient may also wish to expire records after a certain period of time so that a doctor does not have records for unlimited periods of time. For example, a patient going for an initial consultation may wish to expire records after the minimum required period of retention unless he decides to go forward with that particular physician. Furthermore, notes from a patient may be valuable in determining whether something can be archived or not—if a patient is undergoing treatment by provider X for an arm injury and an MRI exists of his arm from several years prior at provider Y it would be useful for the patient to have a mechanism by which to notify provider Y that despite its age, the image is relevant to a current condition, etc. and should be kept available.

Furthermore, today, when patients need a particular medical test performed (for example, an MRI of the lumbar spine) the interpretation of test results is often forced on them, meaning that the providers of the actual imaging services—and not the patient—choose the provider to interpret the results and issue a formal report. Facilities require that images be read by doctors associated with the facilities—regardless of the patient's opinion of those doctors' levels of competence or degree of expertise. This denial of choice in medical care is disturbing not only from a health care perspective, but also often results in unwanted charges to the patient. Worse yet, a facility considered ‘in network’ by an insurance company might utilize an ‘out of network’ doctors for these readings—without the patients' prior authorization, resulting in additional costs, aggravation, and/or paperwork nightmares—for the patient. At times, the current healthcare model may also contribute to medical errors as physicians who receive large incomes from medical imaging and/or testing facilities have strong incentives not to criticize the results of a test—for example, to state that an MRI was performed improperly or produced an unclear images and must be redone. This monopolistic system is bad for people seeking healthcare—both medically and financially. Decoupling the performing of a specific test from its interpretation, and allowing patients to include comments for any provider reading the results, provides people with more control over their health care, empowers them to make the decisions that impact their health, and would likely improve objectivity and reduce costs and mistakes.

Furthermore, today there is no way to search medical records across multiple systems from a single portal. So, if a person wants to search for all references to his blood pressure in all doctor records from the past ten years, for example, there is no way to do it. This is a major inconvenience and can adversely impact medical treatment.

Also, as alluded to earlier, the information in medical records as sent to a provider typically include notes, records, images, test results, and other materials created by providers—but not comments of the patients themselves. Unless a patient accurately reports all details about a specific situation, condition, treatment, ailment, drug reaction, etc. to a provider, and unless the provider also accurately notes everything that the patient has told him—the patient's perspective—and many relevant and important details—may not be fully recorded. Furthermore any notes that a patient wants to provide after a visit with a provider may not be included in any official medical records—despite their value in diagnosing and treating both the particular patient in question as well as others. For example, if the patient has an adverse reaction to a medication that is not bad enough for her to call a doctor he may not report the reaction and that information may not end up in the patient's medical records. Likewise, if a patient finds a particular drug to be less than effective (e.g., for fighting the flu) but recovers from a condition (e.g., the flu) through natural healing and time, she may never report it either. This means that valuable information from the person who knows the patient best may never make it into the medical records. Patients being treated for a particular ailment also have no automated or easy way to find others with the same ailment—so discussions about doctors and treatments is not simple—they need to manually locate people—perhaps by searching on the Internet and hoping that the information that they find is real, from real patients who really have a similar condition, and not from people who may either be friends and family of a provider, or, on the other hand, someone with a gripe against a provider. Additionally, medical records and dental records are almost never shared between doctors and dentists—also adversely impacting medical care. Wouldn't it be relevant to know, for example, if someone who frequently has infections in his foot has also had infection-like pain in his mouth two days prior to each infection?

Even if the ultimate goal of true electronic sharing of all medical records is not achieved for quite some time, or if true total freedom of choice vis-à-vis doctors remains elusive for some time, or even if either of these goals are never fully achieved, with the current invention many significant improvements can be made over the current situation. Furthermore, invention, as well as portions of it, can be applied to non-medical related data and needs to derive benefits as well.

### THE INVENTION: SUMMARY

Contemplated within the scope of this invention are several novel elements which may be implemented independently or together; each one in itself is an invention as well. They may be used by themselves, or in combination with other inventions, systems, and/or technologies. Any examples provided below are meant only to be illustrative of only one particular implementation of the invention.

To this end, one novel aspect of the present invention provides a novel system for a patient-centric system that allows people to manage their medical records, or any other form of records—without the need to store all of the records in a central repository, online, on a mobile device, or on a home computer. By allowing medical information to reside at providers—as it does today—the invention eliminates the classic psychologically-challenging (i.e., scary) requirements placed upon users wishing to have online access to their medical records of storing sensitive personal information on equipment belonging to the medical-records-online-system provider. The method for achieving these goals is another novel aspect of the invention, as is the computer code to perform this.

In a certain sense, and as a novel aspect of the invention, the invention represents the introduction of a Web 2.0 or social networking paradigm to medical records management—while such an approach is novel, it truly represents a shift from technology and provider-centric EMR systems to a system that better represents the way humans think about healthcare and medical records. This invention is not simply a “Facebook-like interface for medical information” which would inherently suffer from the same drawback of storing information, would require manual uploads of information, etc. but an entirely new way of allowing medical-records management, distribution, and communication.

One important novel aspect of the invention is the use of human psychology, and psychological research related to the human factors of design, in the design of the medical records management and communication system in order to ensure ease of use, effectiveness, security, and privacy are all optimally delivered. The invention uniquely leverages an understanding of the humanistic principles of the mind as they apply to the way people think about medical records; the invention, which is based on such principles, therefore offers a user interface and experience that reflects the way people already think about medical records rather than the way technology works, simplifying usage, improving user acceptance, and helping to ensure security is maintained.

One important novel aspect of the invention, therefore, is that each individual gets to control through a central system who gets to see what, and what information is shared with whom—even though that information may not reside on the system. People store their medical records not as collectibles—but to provide to healthcare providers so as to get the most accurate healthcare. As such, clearly storage is not the ultimate goal, rather the goal is directing of the right information to the right parties at the right time. Hence, a system that allows that without the storage still achieves the user's goal—albeit without the drawbacks that users often (rightfully) dislike.

While many users may not wish to store some or all of their data at a provider, the invention would also include the ability to allow users—if they so desire—to automatically store specific portions of data or all data once it is received from a provider either temporarily—for example if an intended recipient is not able to receive it at that point in time due to not participating in the invented system, technical issues, or whatever—or for the long-term. Today's systems do not do this—the user obtains the information and then has to load it into the system. Part of the present invention would also be the system, method, and computer code to secure the data by encrypting it with the public key of a public-private pair belonging to the user—or using a symmetric encryption algorithm whose key is encrypted with the aforementioned public key—in some variant of this type of model—so that in its stored format it cannot be accessed by anyone other than the authorized user (who possesses the private key or the credentials to decrypt the private key stored at the provider or a related key depending on the exact implementation—the point being that a public-private model can be used to secure the data with the private key belonging to the user storing it).

Another novel aspect of the invention is the establishment of relationships between parties: When a user enrolls in an implementation of the invented system, he, may for example, select with which providers he wants to note a relationship (i.e., parties to whom he plans to either send records, receive records, communicate, etc.). He can also make such selections at a later time. If those providers already utilize the invention then the process would be totally automated. If not, they could be invited to join via email, messaging, or even fax or phone through an automated process, or could use the system without fully registering as well—for example, links to specific requests could be send to them.

Another novel aspect of the invention allows a user to obtain medical records electronically from providers or to direct the delivery of those records from one provider to another—without the information being stored in a central repository. Another novel aspect allows the user to granularly specify which records should be provided to whom, or to select multiple records together. It also allows people to obtain readings on medical records from providers other than the ones associated with imaging and testing facilities, breaking a monopolistic situation that has plagued Americans for decades.

Another novel aspect of the invention is the system, method, and computer code that allows the establishment of medical “patient grouped team” (henceforth referred to as a “team”) based on relationships with an identical patient and authorization from that patient—that is multiple providers whose having a relationship with the same user (e.g., patient) creates a de-factor group—if the patient so allows. It also allows for simultaneous sharing of information with multiple physicians and/or other providers and facilitates communication amongst them about the patient. This is achieved, in one example of the invention, by a user logging into the system, selecting multiple recipients for a specific medical record and instructing the system to deliver it to all of them, and (either by checking a checkbox when sending the records to the group to also make them into a team, or by using a separate interface) instructing the system to make them a “team” that can discuss the records. The system, in this example, would then provide an interface to the team members to send messages amongst the team, allow newsgroup style posting for and to members of the team.

As part of this novel aspect of the invention it is important to understand that multiple providers may be members of a team, as may multiple users—if the user upon whose identity the team is based so allows. A single patient may have multiple teams—as he may have multiple parties working to treat a specific condition whom he does not want seeing medical records about some other condition.

Another novel aspect of the invention is the system, method, and computer code that allows non-providers access as “other authorized parties”—this may include, for example, a patient/user's spouse, parent, or child, or the lawyer of a patient being treated for injuries sustained in an automobile accident, or some other party authorized by the user to see some or all of the medical information. The system would allow such parties to be given medical records as directed by the patient, as well as to be enrolled into—or join—teams when such approval is given by the patient. The patient may do this on a record by record basis or may configure that, a specific provide or group of providers is automatically to be considered a member of all new teams unless actively removed by the user.

Another novel aspect of the invention would be the system, method, and computer code that allows providers—for example members of the same team—to collaborate with regard to the information or the patient. In one example of the invention the invention achieves this through a messaging interface and file sharing capabilities.

Another novel aspect of the invention is the ability for providers to simply flag when medical records will be archived/removed from their repositories so that patients can ensure that they have copies prior to those occurrences, or can make a request that such records be retained longer, etc. This fixes a serious problem that exists today as after some period of time providers may erase medical records or store them in some difficult-to-access archive. Since old medical records can often be very useful in treating a condition, doing so adversely impacts patients heath care. For example, if a patient is complaining of head-aches and had an MRI of her brain 10 years earlier it might be useful to see that MRI when diagnosing now so that it can be compared with any current MRIs or findings to look for any changes. A novel aspect of this invention is the ability to provide an expiration date on any or all medical records so that patients can see when archiving may occur and take action prior to those occurrences to obtain either a copy of the records or to have them sent to another provider. Providers can flag the dates-for-archiving, length-of-retention, etc. either in their own EMRs and the information would transfer to the invented system, or can enter it directly into the invented system. Another novel aspect of the system is how the “expiration date” on medical information is communicated to users. While such information is essentially not conveyed to patients at all today, the invention includes three novel ways of doing so—(1) By putting the date or time-to-live information or both within the display of any medical record when it is shown in a list—as one example: “MRI of Right Shoulder—Taken Jan. 1 2010 To be retained until Jan. 1 2015” (2) By allowing the user to access a list of all medical data accessible to the system (or known about by the system) along with corresponding time to live and retention-end-dates and allowing the user to sort on those dates. (3) issuing warnings to users when data is close to expiration date. The definition of “close” can be set by the user in the configuration of her account on the invented system.

Another novel aspect of the invention would be the system, method, and computer code that allows providers who are not utilizing electronic medial records systems—or EMRs that cannot communicate with the invention for whatever reason (e.g., not connected to the Internet, not yet compatible, etc.) to benefit from it. This highly unique aspect of the invention works by allowing patients to issue requests for medical data from providers—in some cases in an identical fashion to the way they make requests from providers whose systems can communicate with the invention and in some cases perhaps differently—while those requests cannot be handled in an automated fashion instantly, those requests are either transmitted to the providers (whether via email, fax, phone, physical mail, etc.) or made available to them via a simple web page. To patients the benefit of this invention is that the process of medical records requesting is centralized, under the patients' control, with a simple interface to obtain records, through a unified system and that multiple records can be requested from one or more providers at the same time regardless of the providers' technical capabilities. For providers this simplifies—and reduces the cost—of providing medical records (which providers are required to do by law)—instead of people calling their offices, or saying they will “stop by” for records, the providers can direct patients to the invented system.

Another novel aspect of the invention would be the system, method, and computer code that allows any parties authorized by a patient/user to be members of a team relating to that user. Another novel aspect of the invention is that patients have control over his or her teams through a team list in the invention—people don't like that specialist doctors treat specific ailments out of context of other medical treatments—by creating specific teams each doctor gets a better whole picture. That said, sometimes people do not want doctors to know about all their medical information for whatever reason (e.g., there is no reason a dentist needs to know that the patient is seeing a psychotherapist for treatment for anxiety), so different teams may have access to different information and the invention includes the method, system and computer code to do so.

Another novel aspect would be the collaborative ability to send messages between parties authorized to do so within a team.

Another novel aspect is the ability for a patient to decide if he wants to be notified when a team member or other authorized party either accesses a medical record of his or adds information/communication to the team communication, and to have the automatic notification performed per his desires.

Another novel aspect of this invention is a central system that allows users to choose medical records from providers and direct them to other providers or to a repository, to select providers with whom they have a relationship and establish communication, to receive messages from providers attempting to create ‘relationships,’ to see which parties are available to read images and test results and issue a report interpreting, to select such providers and to send images to parties. A provider joining the system may enroll his entire user base—of course each user would need to “Approve” the join for it to actually occur. This could be done manually (through signed consent forms, etc.) or automatically (via messaging, emails, etc.) depending on the parties involved and local laws.

Another novel aspect of the invention is the system, method, and computer code that relays medical data from a provider when requested. This key, unique aspect of the invention an be achieved via separate agent code deployed at the provider which accesses the provider's EMR or its databases directly, or which may information via “screen scraping” the EMR, or may access information by logging in as a specific designated special user on the provider's system (in this case user refers to a provider login in the provider's system), or may work otherwise.

Another novel aspect of the invention is that users (i.e., non-providers) can select providers which to have relationships, providers can add users with whom they have a relationship, new users and providers can sign up, providers can “recommend” users to join and users can “recommend” providers (in the social networking sense—for example (in one example of the invention this might entail the invited party receiving a link to enroll in usage of the invented system). In one example of the system this—and every other function described—could be done via a web browser on a computer or mobile device, or via an applet on a mobile device, or via client software on a computer.

Another novel aspect of the invention is the ability to provide advertising to relevant healthcare entities based on the medical information a user transmits, from whom he transmits it, and/or to whom he transmits it (rather than information actually stored in the system). Since users typically transmit information most relevant to present situations, the invention optimizes advertising for that about which a patient cares most. A firm advertising physical therapy services in New York City, for example, would likely be far more interested in advertising to a patient sending MRIs of the lumbar spine to a physiatrist in New York City than someone sending different types of records, or someone sending the same records to a physician in San Francisco, for example, This is very different that keyword based advertising as is common today, and provides much greater relevance to the user—and much more value to the advertiser as it more accurately finds matches for prospects' for the advertiser's products, services, etc.

Another novel aspect of the invention are various security controls, models, methods, and systems as utilized to ensure security and privacy are maintained when using the invention:

Encryption of all communications can be achieved by leveraging standard web encryption (SSL over HTTPS) and encryption of specific records and data can be achieved using additional forms of encryptions using one or more of multiple available methods, including

Initial validation of users to providers could be achieved through physical authentication (e.g., requiring signing a form at the provider's office or faxing it to them, or communicating with them by phone), or could utilize other methods. For example, one novel aspect of the invention would be the establishing of accounts to manage medical information and authorization based on knowledge-based authentication (e.g., answering a question or series of questions to which the user would know the answer to but to which other people would likely not know the correct answer). This type of technology has classically been used in the financial vertical—but not in healthcare. What has existed in healthcare has been challenge-questions which is a very different approach than knowledge based authentication. Challenge questions means that a when a user sets up an account she picks several questions and provides the answers (e.g., what color was your first car)—on subsequent logins the user is asked the questions and must answer the answers that she previously provided. This does nothing for ensuring the authenticity of a user's identity upon enrollment in the system or upon initial communications with a provider. Using knowledge based authentication to establish trust with a doctor online has not been done to date and is a novel aspect of this invention. Using knowledge based authentication to establish trust with a medical records system has not been done to date and is a novel aspect of this invention.

Encryption can be achieved using one or more of a variety of methods, including (but not limited to) private-public key type structures. As alluded to earlier, records stored could be encrypted with a public key of a user storing the records (so that only the possessor of the private key and the credentials to unlock the private key can access the data) or with a symmetric encryption algorithm whose key is encrypted using the public key of the user storing it. Records which are transmitted from party X to party Y can be encrypted with SSL to protect the communications as well as the Public-Key or Symmetric-Public-Private model to ensure security.

Another novel aspect of the invention is the use of a single source of trust across multiple medical providers for the purpose of authenticating users wishing to establish relationships with healthcare providers and/or to direct healthcare information between providers. For example, a user may be required to authenticate his identity prior to establishing a relationship with any particular provider (so that the provider knows that the user is entitled to the particular medical records that he may subsequently request), or as part of the invention he may also be able to strongly establish his identity upon initial enrollment or upon establishing the initial relationship with a provider and that single-authorization will prove his identity to any other provider to whom he issues a request for records. This novel approach is works and maintains security as the authorized user is known to the invented system as authorized for a particular user identity and when the request is made to the subsequent provider the request is made with identifying elements for only that authorized user. Additional checks can also be made against the knowledge-based authentication database. For example: A user creates a user account on a system running the invention, and correctly answers a series of knowledge-based authentication questions related to the identity that he claims, and the knowledge based system matches his social security number to the one he provided. The user then requests medical records for himself at an address known to the knowledge-based system database as an address at which he resides. The system then sends the request to a provider—indexing with the user's name, social security number, and address. This is different and a step beyond existing Single Sign On technology as this combines authentication and authorization to access information on a system to which the user has previously never communicated (the new provider's) belonging to an external organization (the provider) in a completely different infrastructure (external).

Another novel aspect of the invention is the method, system, apparatus, and computer code to allow a user to “drag” an icon for medical records/icons for medical records/the name of medical records from party X to party Y/parties ABC (typically from a provider to another provider, although it could be another type of party/parties such as authorized non-providers), and to have this be reflected in the real world with the transmission of that medical information from party X to party Y.

Another novel aspect of the invention is the method, system, apparatus, and computer code to allow a user to send medical records from within a web-based system. By selecting a from provider and one or more records from the corresponding two selection lists and then selecting a recipient (or more than one recipient) and then clicking Send the records can be sent—these actions are reflected in the real world with the transmission of that medical information per the user's request.

Another novel aspect of the invention is the method, system, apparatus, and computer code to allow parties who are technically not medical providers to be considered providers. Records can be sent from an authorized user who happens to store them on behalf of the patient for example, to a doctor.

Another novel aspect of the invention is the method, system, apparatus, and computer code to allow a user the aforementioned capability on mobile devices as well as computers. For example, a user standing in a specialist's office who finds out that records that were supposed to have been delivered to the specialist from a general practitioner were never delivered (or were lost) could simply pull out his iPhone (or other mobile device), touch-run an applet that provides access to a system running the invention, locate the provider of the necessary medical records and the specific records wanted and drag their entry in the list to the name of the specialist. The records would be sent in real time by the system running the invention.

Another novel aspect of the system that emanates from the ability to deliver medical records quickly and easily is that users can easily request that test results be read by providers other than those offered by testing facilities. Furthermore, obtaining second opinions on certain types of matters that do not require in person examination becomes simpler—doctors anywhere in the world can be sent records to examine.

Another novel aspect of the invention is the method, system, apparatus, and computer code to allow a user to aim the camera on a mobile device or computer at himself while performing a chat with a provider in real time and have the images/video transmitted to the provider. This can be useful for a doctor examining a skin condition remotely. In this case another novel aspect of the invention is the use of a human-friendly interface to perform this—for example, dragging a camera icon to a specific provider to initiate the photographing/video-recording.

Insurance companies could benefit as more people would be able to more easily and less expensively get second opinions.

Another novel aspect of the invention is that the standard interface—allowing selection of parties from which to send medical records and parties to receive them—disguises the fact that the method of retrieving the records and of delivering them may be different for different parties. Users don't care how the data gets there—they just care that is does. The system works the way people want it to—the way they think about medical records, not the way the technology underneath actually works.

Another novel aspect of the invention is the method, system, apparatus, and computer code to improve security vis-à-vis establishing accounts by preventing the establishment of accounts for a particular person if there are some specified number of failures to open an account for that person. This is different than all existing failed-login and failed-account-establishment systems in that the blocking of account establishment is not based on a series of repeated incorrect password submissions or on a completely mismatched user information, but based on a series of partial matches of information and knowledge about the user. The fact that an unauthorized party knows some information about a user that we would not expect him to know, but not sufficient knowledge to actually establish an account, may indicate familial fraud or that someone's identity has been compromised. Hence, this unique aspect of the invention can have significant value in defending against fraud.

Another novel aspect of the invention is the method, system, apparatus, and computer code to use an encrypted token to prove that a user has proven that he or she is entitled to see medical information and records with specific identifying information even though the user has never authenticated himself or herself to the system housing the information, nor to any other systems belonging to the organization housing the information. For example, if a user is authenticated to a system running the invention, and has proven his identity not only in terms of successfully authenticating to the system, but has also proven that he is the party associated with medical records bearing matching information—for example, by answering a series of knowledge-based questions that only the party about whom the medical records were established would know how to answer (as described above in paragraph 32), and the system then wants to inform a medical provider's EMR to send records for that user, it may encrypt the current timestamp and the identifying information for the user with the systems' private key, so that the receiving EMR would know that the sender was the system, and, if a paradigm were used in which the system will only request medical information for users it knows are entitled to see them, then the receiving EMR will know that it can provide the medical records despite the fact that the patient never authenticated to the EMR.

Another novel aspect of the invention is the method, system, apparatus, and computer code to use an encrypted token

Another novel aspect of the invention is the method, system, apparatus, and computer code to perform any of the elements or aspects of the system described above for purposes other than healthcare. A similar system could be used to provide various benefits in the publishing industry, legal industry, financial vertical, and many other verticals in which information sharing is critical but information is sensitive and may not be stored on a central system.

To this end, one novel aspect of the present invention provides a novel system that, (and method that, and computer code that when executed) dramatically improves the search-capabilities of medical records (or any other form of data) by using a system, method, and computer code that when executed allows for the indexing of data in heterogeneous and/or dispersed systems that may go offline at different points in time for use by one or more centralized search portals. This would allow a person to search his or her medical records from a central portal—even through the records are stored at many different providers in different systems. (This is a “True Cloud™” model in which data really resides at different locations on different types of systems—not the bogus model where “cloud” simply means Internet-hosted.) For example, today a user simply cannot search through all of his medical records as they sit on many different providers' systems. That is a pity—as there are many occasions where such a capability would prove useful, sometimes perhaps even life saving. The invention allows and enables this type of search—and makes it efficient—by doing the following:

An index (or even a small cache as will be mentioned later) is created of the medical data—indexed on the fields upon which most searches are normally performed or, in some situations, on every non-trivial term in the data (trivial meaning in general “the”, “your” etc.—the kinds of words that would not be capitalized in a title). Indexing may be done when a provider initially installs the invented system or agent for the invention, whenever he adds data, at specific time intervals (e.g., nightly), etc. or any combination of these or using some other convention. The index can be created using standard index technologies. However, the items pointed at by the various indexes that are created are obviously in different formats as they are from different systems. In the situation of the medical records there are multiple benefits provided by the invention. First and foremost, is the ability to search medical records that are stored in multiple sites, using multiple different medical records management systems, from a single interface and quickly obtain appropriate results. Additionally, indexing provides a standard interface into multiple diverse medical systems. A standardized format of entry into the medical data can have other purposes scratch that can be utilized for other purposes as well.

Once an index is created at a particular provider the index can remain there or could be moved to the central portal where the searches will be performed. It could also be stored at the provider and cached or replicated at the central portal—with the cache updated periodically (maybe once a day) from the local index. A replica would constantly be kept in sync with the local index—any changes to the local copy are sent to the portal copy. In any event, by moving the index to the central portal (or at least having one replica/cache of it there) the most efficient search speed can be achieved. Furthermore, an index of indexes for a particular user can be created (providing indexing that speeds up searching through all the use's various indexes) speeding up searches even more. Alternatively, the indexes for a particular user may be combined into a single index. Another advantage of having the index local to the portal—or at least replicated there—is that even if the system goes down at a provider the index for that provider's data is still available for the search engine. This means that a user searching for data can be made aware of the existence of data that may not be accessible at that particular point in time at which the search is being conducted, but which may be available afterwards—knowing that the data exists may be of value since it can be manually obtained now (e.g., a call can be placed to a provider to check certain information), or it can be obtained later and perhaps diagnosis and treatment should wait until after it is obtained. If true caching of data is performed the data may even be available at the time that the provider system is down—more on this later. Once the many indexes from many different providers are loaded onto the central portal several benefits of the invention cab e achieved (a) when a user performs a search the search can occur much faster than it would otherwise, (b) the system can return results from providers' systems may not be online, and (c) network traffic (e.g., over the Internet to the providers) can be reduced. The scheduling for the re-indexing of data, or of updating indexes, to keep the system up to date can vary based on business need technical bandwidth limitations and many other factors. All options with regard to re-indexing scheduling would be included in this invention. One option is, for example, to have an agent at the provider that every time data is added to the provider's database the index is updated locally and the new index information transmitted to the index at the central portal. Or if no local index is actually stored the information is updated on the central portal immediately. Another option might be going to transfer once a day or once a week probably in the middle of the night when nobody is using the system or whenever there are the lowest number of users on the system which clearly depends on the type of provider and the nature of their operations. Obviously, a hospital will be using system 24×7 whereas a general dentist is unlikely to be working from 2-4 AM. Another option is that there is no index stored locally, it is only at the portal but that the transaction information is transmitted up to the portal for every index update—this would involve statements such as add the following, update the following, etc. Index updates—for cache and replica models—could involve either retransmitting an entire local index, transmitting only the new information for the index, or transmitting commands how to update it (add this, delete this, etc.).

Another aspect of the invention is that patients and providers can add notes to electronic medical information. That does not mean that the data will necessarily be incorporated into the medical record system at the provider, although this can be done in one type of instantiation of the invention, but rather it can also be incorporated into the portal and associated with the data through the portal, so that when the data is sent to a provider the notes are sent along side (rather than incorporated within). Either option is an instantiation of the invention. The patient can make notes about various medical records—in the example that we mentioned before of monitoring blood pressure history over a period of 10 years, for example, a patient may note that he was eating salty foods at the time he saw a specific doctor but not afterward, or that during a specific period of time he was going through an ugly divorce which caused him stresses and may have impacted his blood pressure.

Another unique aspect of the invention is the ability to truly social network from a medical sense. One aspect of the invention, therefore, is the system, method, and computer code that when executed allows people to find other people being treated for a condition from which they themselves suffer. The system asks a user if he or she would like to be searchable for any specific conditions. As part of the invention those conditions may be extrapolated from the medical records or provider types that are associated with the patient. Alternatively, or in combination, they may be set by the patient. If a patient chooses to let others know that he is interested in communicating with others who have high blood pressure, for example, others who search for people with this condition will find him and they can communicate directly. The providing of medical-condition related chat and that room capabilities, group communication, group file sharing, blogging, etc. is part of this invention as well. Another aspect would be posting messages on “bulletin boards” about specific conditions, sharing information, asking questions, or asking for people to contact the user if they have information, etc. One instantiation of the invention would be to allow postings (or some types of postings) to be done anonymously as long as the user is a registered user of the system, another might require the user's true identification. An aspect of the invention is the system, method, and computer code that when executed allows a system to scan through medical records to ensure that someone listing a condition as of interest really has/may have it, or, depending on configurations, that a dependent or close relative has it/may have it.

Another invention is the use of this indexing system combined with a medical records portal. If a patient is searching his medical records, and some of those records are on a system that a provider has rebooted, shut down for a backup, or otherwise caused to be unavailable at the time of the search, the use of the indexing system will allow the patient to know that some data exists but is not currently available. This is far better than not knowing that it exists, as the patient can retrieve it later or obtain it manually.

Another part of the invention is the ability to store all the data or a cache of the data as of a certain point in a central repository. Some users may wish to have the data centralized and under their control—so that at least one copy of the data exists under their control rather than under the control of many providers. This can be provided as an option for those users as part of the invention. As with the indexes the caching can be data may be a true consummate replica—receiving updates every time a provider updates the patient's records, or a cache that is periodically/regularly updated but which is not always 100% in sync with the latest data. Even in that case the user may elect to search the cache or to search all providers for latest data. Along these lines, as an option the user may be able to store the data not only in a central repository, but also on his or her own computer, mobile device, USB drive, smartcard, memory stick, etc. When updates occur the central portal can inform the user that the data in his/her replica/s (e.g., on his smartcard) needs updating. When possible an agent can be installed to automatically update these databases as well (e.g., an app on a mobile device or a service on a home computer). A provider could also allow potentially a user to load data from his USB device, mobile device, or smartcard onto a provider's system. Of course, encryption should be utilized when storing replicas of this data. Furthermore, an expiration date built into the database to prevent its use after a certain amount of time passes with it unused or after a certain date may be useful as well to contain the damage in case the device is lost or stolen, and a remote-wipe capability is useful whenever possible as well for the same reason.

Another unique aspect of this invention is the idea, method, system, and computer code that when executed gives the ability to a person, business, or other entity to earn revenue by operating a portal. The cost of obtaining and sending medical records to a particular provider today can be quite high since a patient may need to manually pick them up which can involve commutation costs and then mail them which involved postage costs. One way to earn revenue from the inventions therefore would be to charge for medical record transfers. One novel aspect of this invention, therefore, would be medical system that charges for transmitting medical records, but does not charge for access in the system so user can access all of the records, do whatever searches he or she wants, etc. for free—but has to pay to transfer the data from provider A to provider B—but the cost could be much less than he or she would have to pay without the system so he or she is happy to benefit from the lower cost offered by the system. Another unique way to earn revenue—which is part of this patent—would be through targeted advertising based on medical record information or medical-related user selection as described earlier.

Another novel aspect of the invention is the ability for providers to simply flag when medical records will be archived/removed from their repositories so that patients can ensure that they have copies prior to those occurrences, or can make a request that such records be retained longer so that the records will be available or shorter (e.g., if they are just going for a consult the consult

Another novel aspect of the invention is the ability for the system to scan through someone's medical records and suggest both conditions that may interest them (e.g., high blood pressure) as well as search-limiting parameters to ensure that the people with whom they communicate are really suitable/appropriately matched. For example, someone who has diabetes at age 15 may not wish to search for all people with diabetes, but rather to limit the search as the issues and treatment for diabetes at age 15, and the impact on life of the condition and various treatments, are different than those for a patient aged 85.

Another novel aspect of the invention is the method, system, apparatus, and computer code to use an encrypted token for communication of authentication and/or authorization information between the EMRs and the central portal.

### BRIEF DESCRIPTION OF THE DRAWINGS

FIG. 1 depicts an exemplary implementation of one embodiment of one novel aspect of the present invention where a user selects specific medical records from one provider and sends them to another provider using a select-and-send interface. After selecting the name of the FROM party, the list of available information appears in the What box below, the user selects the items he wants to send, then selects to whom he wants it sent, then presses SEND.

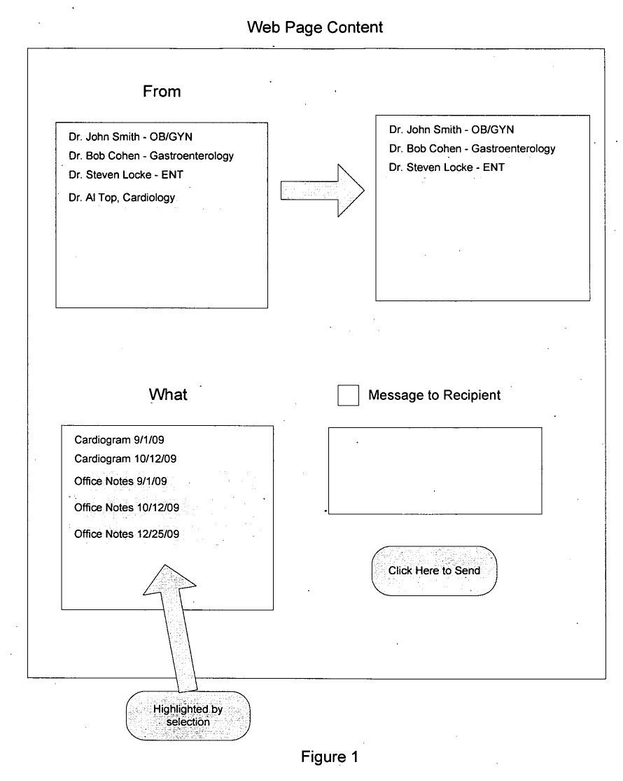

FIG. 2 depicts an exemplary situation where the user sends a medical scan to a provider and requests a report

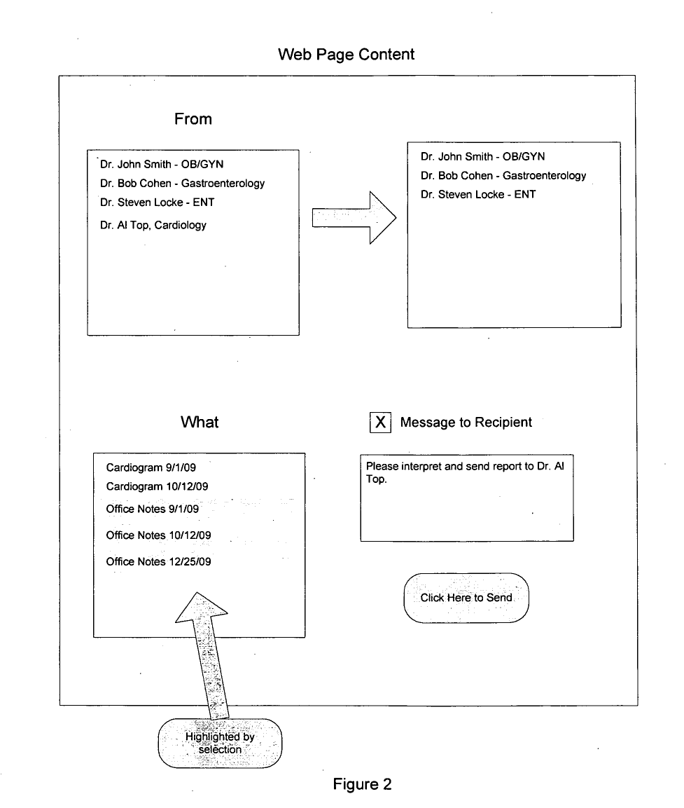

FIG. 3 depicts an example of what a physician using one novel aspect of the invention might see—in this example the physician is not using an EMR that can communicate electronically with the invented system—so he is looking at a web-based list of requests for medical records.

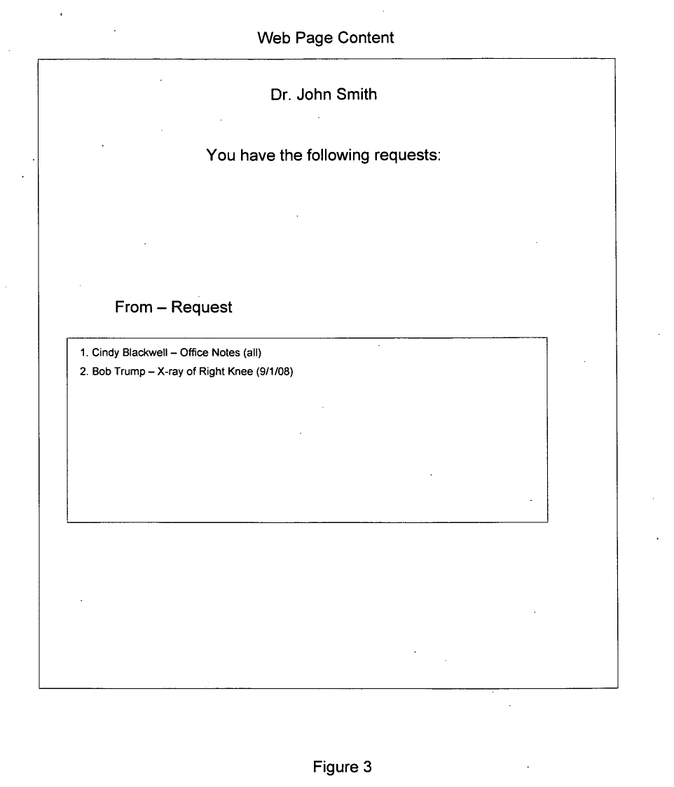

FIG. 4 depicts a sample flow of an exiting user using the system to send medical records

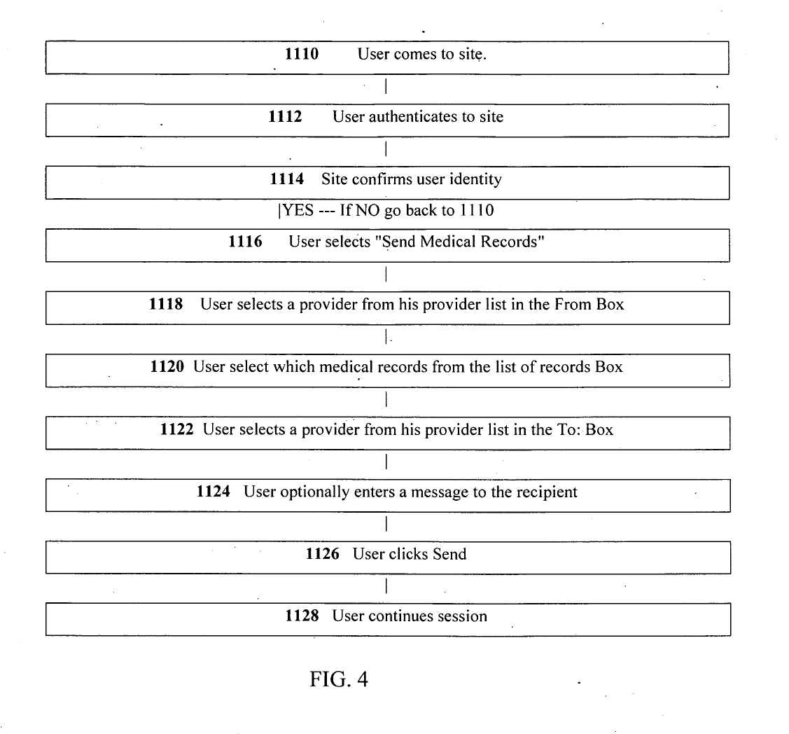

FIG. 5 depicts an exemplary implementation of one embodiment of one novel aspect of the present invention showing multiple EMRs with local indexes that are related to replicas at the central portal. Some synchronize constantly and some update periodically.

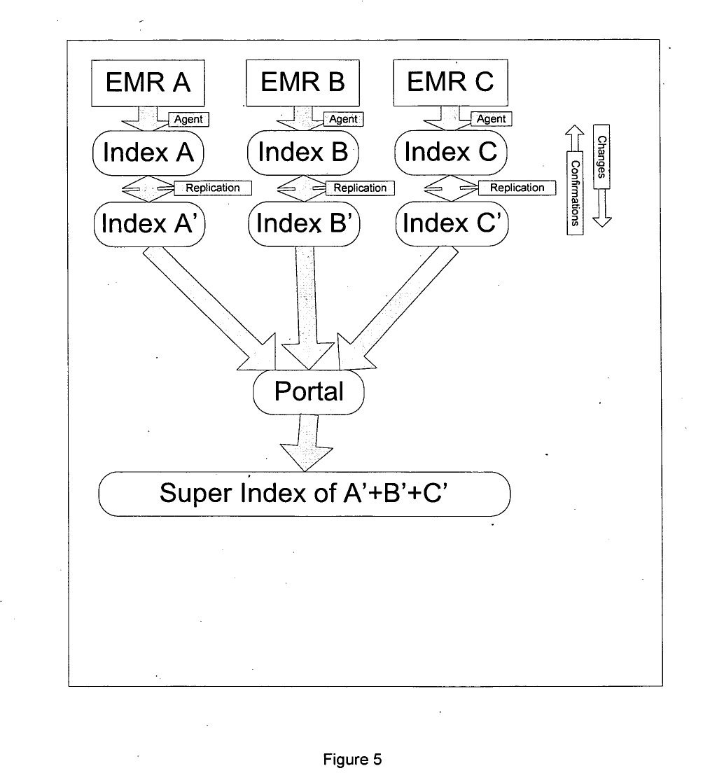

where a user selects specific medical records from one provider and sends them to another provider using a select-and-send interface.

FIG. 6 depicts a user sending a message to another user using a messaging interface that hides the true identity of a user for privacy reasons—to ensure people are willing to speak more openly about medical conditions and provide guidance as best as possible

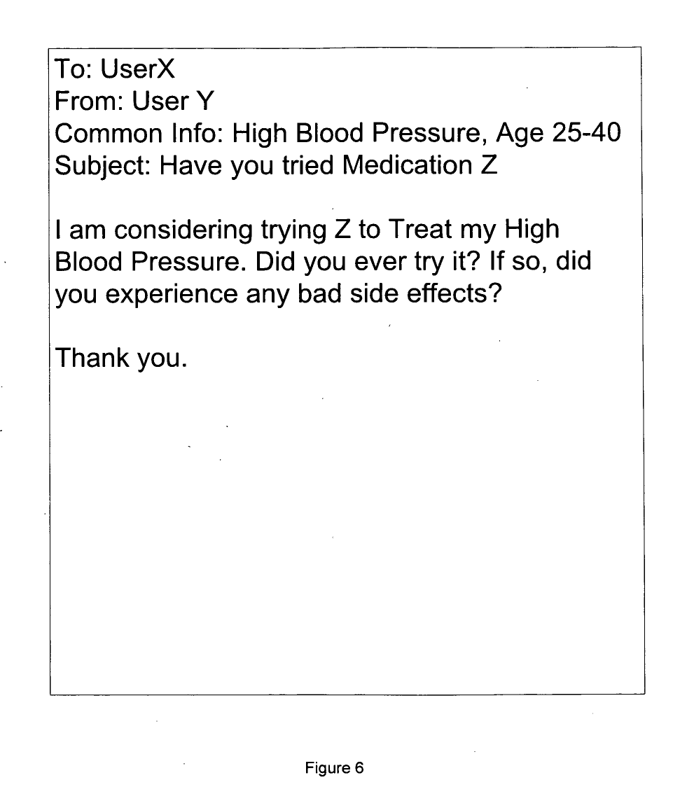

### DETAILED DESCRIPTION

One exemplary implementation of one possible embodiment of the present invention may be shown through the following illustrative depiction involving a patient looking to manage the communication of her medical records. This example is not intended to be comprehensive vis-à-vis all aspects of the invention, nor is it intended to set any rules or requirements for other implementations of the invention, but rather is intended simply to serve as one example of how portions of the invention could be embodied.

When the patient, who, in this example description, we will call Jane, uses the system for the first time, she enters the URL of—or clicks a link to—a system that implements some or all aspects of the invention. Jane sees a resulting web page that provides two options to the user—to log in with existing credentials or to set up a new account. Since Jane is a new user using the system for the first time, she needs to register as a new user. She clicks the new user button or link and the system shows her a page that allows her to create an account.

On the account creation page, the system asks the user to select a username and password, as well as for identifying information that can be used to match her identity against medical records at various providers. While Jane is not required to submit any information which she is not comfortable providing, the more information she does provide the easier it will be to match medical records to her at more providers and the greater the benefit of automation will be for her. For example, Jane is not required to provide her social security number or medical insurance ID number. However, since some physicians track medical records indexed by those numbers, it will make establishing a match between her identity and her records easier if she provides them. If she chooses not to, that is also OK, then matches can be made based on other information—for example: name, birthday, and mailing address. (The more items she provides the greater the match accuracy, and since the invention always works in a fail to deny mode—that is, unless the system has enough matching criteria to be sure that the records belong to the user for which it is seeking records, it will not provide them—it is not just an issue of matching, but of establishing sufficient matching criteria to ensure that the matches are “trusted” as being correct matches. Furthermore, matching on indexed information is faster.)

Jane provides the information which she is comfortable providing, selects a username and password and clicks submit. The system checks that the Username is unique, and if not prompts Jane to select a different username. The system checks that the password meets any particular password restrictions and regulations that the system may have (for example, that passwords must be 6 characters long and contain at least one letter and one number); if the chosen password is not acceptable per the system's rules the system will prompt the user for a different password.

To check that the user is in fact who she claims to be—in a process that we can call authentication of the initial account establishment—the system may then take the information that the user provided about herself and—either through a database or set of databases located in the same technical infrastructure as the system or through the use of an external service accessible via API or web interface—locate various pieces of information about the user that the user would know but that others are unlikely to, and poses an appropriate series of questions to the user to which a user's answering the correct response would indicate that the user is likely authentically whom she claims to be. Questions could include, for example, what is the approximate size of the user's current mortgage payment and to whom is it made, which of the following streets did you never live on, etc. If the user successfully answers the questions she is allowed to continue to the next stage, if not, then additional questions may be asked, and after a certain number of failures the system may cancel the request to set up an account for some specific period of time.

Once the user—in our example, Jane,—is authenticated to the system, the system offers the user the opportunity to configure her account which includes setting various options, entering contact information, etc. The user is also given the opportunity to setup a list of providers as preferred providers to store in her profile so that she can easily select to have medical records retrieved from them. The list of available providers that this particular system makes available by default to this user will be selected from lists (in order of preference—although the user can pick which of the following she wants used to assemble choices) of (a) all providers with whom the user has interacted via the system to retrieve or send medical information that the user has instructed the system to store in her profile—in Jane's case this is her first usage of the system so there are none yet (b) providers with whose EMRs the system has electronically communicated in the past (c) providers with whom the system has communicated via non-automated medical record communications in the past (d) all providers known to the system from a database compiled from insurance company, licensing boards, etc. (e) User entered other providers (the system allows Jane to enter a provider not found on the list and enter the provider's contact information, etc.)

In this example, let us say that from the list Jane selects her general practitioner. The system displays that provider's contact information and asks her to confirm the information for this physician is correct; Jane clicks yes, and the system stores this provider as a preferred provider in her profile. Jane repeats the process for her dentist, OB/GYN, and Cardiologist.

In our example, Jane wants to send her recent cardiogram—conducted by her cardiologist—to her OB/GYN. She clicks to go to the Send medical records page. On this page in the TO: selection box she selects to see preferred providers only, so only four providers are visible. (The system may allow for there to be preferred sending providers, preferred receiving providers, and preferred both providers—so that the user can have some providers by default appearing only in the To or only in the From boxes—but in Jane's case she assigned them all to be preferred in general, i.e., for both).

In the To, box Jane selects her cardiologist. Since Jane's cardiologist utilizes an EMR that can communicate with the system (either through an agent or directly), and has previously registered with the system, Jane's selecting him causes the system to automatically retrieve from her cardiologist a list of available materials. In Jane's case there are a series of office notes, sorted by date, as well as two cardiogram test results and corresponding reports also sorted by date. In the case of this system, the default configuration is that the cardiograms and office notes are sorted by date in separate “folders” titled “tests” and “office notes,” but they may also appear sorted simply in a single list by date—just that Jane has not changed this configuration option in her profile. Jane only wants to send the most recent cardiogram information—so she selects this cardiogram from the list.

To clarify—how did the system and the cardiologist's system communicate so that Jane could see the list of records? The system either encrypts the request for Jane's medical records listing from the cardiologist using the cardiologist's PUBLIC key and sends the request over the Internet to the cardiologist's EMR system, or simply establishes an SSL-encrypted session to send the request over an encrypted connection. To prove the identity of the sender the system as well as the authorization of the user requesting medical records, in this example, the system also sends a date-and-time-stamp of the current time combined with the identifying information about the user and the request for the data—all of it encrypted with the system's own PRIVATE key. Upon receipt, the agent on the EMR system that receives these requests, decrypts the message, and, since in this example the system used the encrypted-date as authentication as well the system checks that by decrypting with the system's public key and checking that the result offers within it a timestamp within the last few minutes (or whatever period of time the administrator wishes to allow before requests are deemed to have timed out). The agent on the EMR system then compares the identifiers in the request to the index of its own database. It finds the proper records by looking for records with matching identifiers as described earlier (Social Security Numbers, Name, Address, Birthday, Phone number, Medical Insurance ID number are all examples of identifiers that can be combined with various permutations to make a match), and the data about the quest by title (in our case, for example—“Cardiogram Results—Jul. 1, 2009”).

Jane then needs to specify a recipient for the records. Similar to the way she picked the FROM provider, she picks a recipient or multiple recipients. The system then adds them from the TO select box to the TO list which she is asked to confirm. She is then prompted if she wants to add a message to be sent along with the records—either a single message to all recipients, or, if there are more than one recipient, does she want to send each one an individually written message. In our example Jane is sending the records to one recipient, her OB/GYN, and wants to send a message along with it. So Jane enters the message into the message box and clicks send. The system then displays a message saying that the transmission of decimal records is being processed. Because, in our example, the system is aware that Jane's OB/GYN and cardiologist are BOTH using EMRs with which the system can communicate (it is aware of this because the providers have previously enrolled), the following takes place behind the scenes and invisible to the user (Jane): Over the session used to retrieve the list of information available from the FROM provider, the system requests the data from the EMR's agent, the agent obtains it from the EMR—in our example, this is done depending on the particular EMR the cardiologist is using either by accessing the data directly or by impersonating an authorized user of the EMR logging using it. The system then sends the medical records to the recipients along with the message that the user, Jane, specified. The transmission may be send encrypted with the recipient's public key, and may use the encrypted-timestamp and data model to prove authenticity as well.

Alternative identity proving systems such a client certificates could be used.

Since the OB/GYN is utilizing an EMR that supports the system, the agent on the his EMR receives the data from the system as transmitted across the Internet. The transmission works similarly to the transmission of the data from the cardiologist—either SSL is utilized for the entire session, or the data is encrypted with the recipient's system's PUBLIC key and decrypted with its private key. Depending on how the recipient's organization has configured its systems the data may be automatically entered into its EMR or may be queued for acceptance into the EMR by a person, in which case a standard web-browser-based interface may be provided by the system or the EMR itself may have an interface for importing that already suffices for this task.

If Jane, however, had transmitted data from a provider who does not have an EMR connected electronically to the system, the system in our example would display a message to that affect to Jane and offer Jane several possibilities based on what information is known to the system.

If a From provider's fax number is known to the system, for example, the system would ask as a choice if the user (Jane) would like the system to send a fax to the provider from whom the request is being made asking for the records to be sent to the intended recipients, and the methods offered for sending to the recipients that would be listed in the fax will depend on what knowledge the system has vis-à-vis contact information for the recipient/s. If it knows email addresses it will offer to send via email, if it has a fax number it will offer to fax, if it knows a mailing address it will offer to mail. If there are any fees involved for performing any of the services—either from the FROM provider or the system itself it will ask Jane if she approves the charges and charge it to Jane's account, or prompt Jane for a credit card number or other payment source if no payment information is stored in Jane's account. Likewise, if the From Provider's email address is known the system will offer to send the message asking for the data by email. If neither email nor fax is known it will offer to send it by mail. If that is not known either the system will prompt the user to enter the contact information for the provider.

In our example let us assume the OB/GYN is not using an EMR system that can speak with the system, or is but never registered it with the system, and neither the system nor Jane know his email address, but his fax number is known to the system. After submitting the request for the data to be transferred, the system shows Jane a message that an automated data transfer is not available and the system will need the user (Jane) to specify a method for delivering the data. Since the recipient's fax number is known the system offers fax as a method. If Jane selects this method the data obtained electronically from the provider will be faxed to the recipient. Additionally information on how to enroll in the system is included in the fax. Should the fax not successfully transmit the system will try several times (per the default configuration that Jane did not modify). If the fax successfully transmits the confirmation will be sent to Jane (part of her enrollment asked where update messages should sent—normally this is an email address), if it doesn't Jane will be notified of this as well.

If the FROM doctor—in our case the cardiologist—has an EMR that does not communicate with the system, or has no EMR at all, the system handles the process differently. In our example, when Jane clicked that doctor as the selection for the FROM provider, the system would be unable to retrieve a list of medical records from the provider. It will then offer Jane to email, fax, or mail to the provider a request for medical records, an offer to enroll in the system, an offer to obtain agent information for various EMRs, and possibly for other related tasks.

Whenever any information is passed through the system—as in our first example of the TO and FROM providers communicating from their EMRs through the system—the patient (in our case Jane) is given the option of storing this info for subsequent use.

Whenever data is requested to be delivered via fax a fax number can be provided that causes the data to be added into the system (i.e., the fax images are stored in the system); likewise an email address that feeds the data into the system can be provided for situations in which data will be sent via email. This allows for non-direct transmission of data—but is an option available to patients who want to store copies of the data within the system.

When providers want to enroll they likewise use a web interface. To prove identities one-time-password authentication can be used—for example, when a provider enrolls the system can look up his known phone number and call it and read a one-time-code over the phone line—with the code being needed to sign up as a provider. Other options for authentication can be used as well. Once a provider is registered he can obtain agent code for his EMR, perform configuration changes, look for messages in the a messaging tab, see which “Teams” he is listed as being a member and review content, etc.

In another example, let us say that from the list Jane selects several providers which are known to the system. The system then contacts the agent software on the providers' networks and asks them to look for and index all of Jane's records. Jane's records may be identified, for example, by her Social Security number, the combination of her name and address, or other criteria. The systems each perform the search and create their own indexes into Jane's data. They transmit this information to the agent which assembles and index into the indexes. This will greatly expedite searches.

Later Jane wants to display her medical record list. The system quickly obtains the list by listing out all the records in its index. Next to the providers at the top level of each list of records there is information as to how current that list is—that is, when was the index last updated and how long ago that is. If she wants, Jane can click a button on the screen to have the system go out to each provider's system to check for index updates at this point. The system may also go out to providers periodically automatically as well, for example at 2 AM everyday. Jane does not click the button since she sees what she is looking for in the existing list.

The agents on the various medical systems update their indexes—some periodically some by updating the index every time a record is added to the EMR. Some of the agents are set to push their updates to the portal when they make them, others update periodically—in this example at 2 AM every night.

Jane also decides that she wants to search for people who want to discuss high blood pressure treatments so that she can discuss their experiences as well as her own to help her make some decisions about a new treatment that her primary care physician proposed to her. She goes to the Social Communication page on the portal and selects set up a profile. She selects “High Blood Pressure” as a condition that she wants to discuss. She also selects and age group of 25-35 as she is in that age group and does not want to discuss treatment for elderly patients and others whose condition and treatment may impact them in different ways than her general age group. In one instantiation of the invention the system offers to scan through her medical records and suggest conditions that are applicable to her to see if she has interest, as well as sets up various other related parameters based on medical understanding rules for those conditions and parameters (such as setting an age range specification, or sex specification when these truly impact treatment). Jane decides not to select that option. She selects her criteria and then asks the system to show her (a) groups that are discussing those topics (b) others' contact info or method of contacting (for those who have agreed to share their contact info with others who search). The portal that Jane is using (the sample instantiation of the invention) allows only those who are willing to be found and contacted to find and contact others. Of course the contact info that is shared is up to each participant—it could be a simple interface through the portal that allows others to send Jane messages and Jane to send to them—without revealing anything about their true identities, or a user (e.g., Jane) may have elected to put more information about herself. That is up to the system's rules—and each user's comfort levels. But the ability to have anonymous social networking about medical conditions is an important aspect of the invention. Jane finds Bob—who has set up his privacy permissions not to allow any information about himself to be revealed other than his first name. Jane uses the messaging interface to send Bob a message asking if he is familiar with the treatment in question. Bob—using the same interface—responds that he has had it and that it worked well for him. Jane explains in a message that she is considering it and asks if he would be willing to speak by phone, online chat, mobile text messaging, etc. Bob agrees, states that he would prefer to speak via phone, and provides his number to Jane. They communicate by phone—offline—and Jane gains the comfort level that she needs to elect to proceed with the treatment.

Later Jane decides to invite multiple people who have listed high blood pressure as a condition into a chat room so that they can all share their experiences together. The parties are invited by their screen-names or first names—so that until someone actively states his or her true name all of the correspondence and communication is confidential. This allows people to be frank and open. Of course, as mentioned before, the system can check to determine that the people (or, depending on configuration, any of their dependents or immediate family members) really do have the condition that they are describing before allowing them to list it as an interest/participate

Another aspect of the invention is that medical records can be searched for references to things related to the condition in question—so that even though communications are anonymous, there is a level of comfort in knowing that the person on the other side of a communication really has a relationship with the condition in question.

1. A method of providing a social networking type system for medical records in which people establish digital relationships with other people or organizations allowing them to communicate and share medical information with controls as to who sees what.

2. A method of claim 1 in which medical records or other information is managed without a central repository, but in which a centralized access portal may exist, and which may optionally allow users to store data in a central repository and/or local copies on computers, smartcards, smartphones, USB drives, or other devices on a temporary or permanent basis and which may optionally sync any replicas.

3. The method of claim 2 in which data is pulled from heterogeneous systems at data providers in either real time or via batch mode, via an agent hosted at a data provider or another location, with authentication managed either at each heterogeneous system, each provider, or centrally via some form of encrypted token to prove that a user has proven that he or she is entitled to see medical information and records with specific identifying information even though the user has never authenticated himself or herself to the system housing the information, nor to any other systems belonging to the provider housing the information.

4. The method of claim 3 in which people can direct—via some electronic interface—medical records (including specific records or groups of records), to be transmitted from one party to another, using a human friendly interface such as (drag-and-drop).

5. The method of claim 4 in which parties can note retention, archive, or removal times for data so that other parties can backup data for future use prior to it become less accessible or inaccessible.

6. The method of claim 1 in which providers not yet using Electronic Medical Records systems that can use the aforementioned methods—and patients of these providers—benefit by having electronic requests converted to email, fax, voice, or other forms which they can receive with their responses optionally converted to digital formats.

7. The method of claim 1 in which non-providers, or non-providers acting as providers, act as authorized parties to obtain information and collaborate, and/or in which non-medical-providers are allowed to add notes to medical information for purpose of improving knowledge and performance, and/or in which multiple providers whose having a relationship with the same user (e.g., patient) are allowed to create a de-factor group—if the user so allows—so as to achieve simultaneous sharing of information with multiple physicians and/or other providers and facilitates communication amongst them about the patient.

8. The method of claim 2 in which data from heterogeneous databases in multiple locations is indexed to improve performance of performing queries on that data.

9. The method of claim 2 which includes producing advertisements and marketing to people based on medical information that they transmit, have stored, or that they otherwise indicate their interest.

10. The method of claim 3 in which a decoupling of medical testing and test reading exists meaning that medical testing is separated from analyzing and reporting test results so that patients can have tests performed by one provider and the results analyzed (or read) by a provider/providers of their choice, for either a first or subsequent reading.

11. A computer-readable storage media that contains a program that when executed by a computer provides a social networking type system for medical records in which people establish digital relationships with other people or organizations allowing them to communicate and share medical information with controls as to who sees what.

12. The computer-readable storage media of claim 11 that contains a program that when executed by a computer manages medical records or other information without a central repository, but in which a centralized access portal may exist, and which may optionally allow users to store data in a central repository and/or local copies on computers, smartcards, smartphones, USB drives, or other devices on a temporary or permanent basis and which may optionally sync any replicas.

13. The computer-readable storage media of claim 12 that contains a program that when executed by a computer pulls data from heterogeneous systems at data providers in either real time or via batch mode, via an agent hosted at a data provider or another location, with authentication managed either at each heterogeneous system, each provider, or centrally via some form of encrypted token to prove that a user has proven that he or she is entitled to see medical information and records with specific identifying information even though the user has never authenticated himself or herself to the system housing the information, nor to any other systems belonging to the provider housing the information.

14. The computer-readable storage media of claim 13 that contains a program that when executed by a computer provides an interface for people to direct medical records (including specific records or groups of records), to be transmitted from one party to another, using a human friendly interface such as (drag-and-drop), and then performs that transfer.

15. The computer-readable storage media of claim 14 that contains a program that when executed by a computer allows parties to note retention, archive, or removal times for data records so that other parties can backup data for future use prior to it become less accessible or inaccessible.

16. The computer-readable storage media of claim 11 that contains a program that when executed by a computer allows providers not yet using Electronic Medical Records systems that can use the aforementioned methods—and patients of these providers—to benefit by having electronic requests converted to email, fax, voice, or other forms which they can receive with their responses optionally converted to digital formats.

17. The computer-readable storage media of claim 11 that contains a program that when executed by a computer that allows non-providers, or non-providers acting as providers, to act as authorized parties to obtain information and collaborate, and/or in which non-medical-providers are allowed to add notes to medical information for purpose of improving knowledge and performance, and/or in which multiple providers whose having a relationship with the same user (e.g., patient) are allowed to create a de-factor group—if the user so allows—so as to achieve simultaneous sharing of information with multiple physicians and/or other providers and facilitates communication amongst them about the patient.

18. The computer-readable storage media of claim 12 that contains a program that when executed by a computer indexes data from heterogeneous databases in multiple locations to improve performance of performing queries on that data.

19. The computer-readable storage media of claim 12 that contains a program that when executed by a computer produces advertisements and marketing to people based on medical information that they transmit, have stored, or that they otherwise indicate their interest.

20. The computer-readable storage media of claim 13 that contains a program that when executed by a computer decouples of medical testing and test reading exists meaning that medical testing is separated from analyzing and reporting test results so that patients can have tests performed by one provider and the results analyzed (or read) by a provider/providers of their choice, for either a first or subsequent reading.

21. An apparatus that provides a social networking type system for medical records in which people establish digital relationships with other people or organizations allowing them to communicate and share medical information with controls as to who sees what.

22. The apparatus of claim 21 that manages medical records or other information without a central repository, but in which a centralized-access portal may exist, and which may optionally allow users to store data in a central repository and/or local copies on computers, smartcards, smartphones, USB drives, or other devices on a temporary or permanent basis, and which may optionally sync any replicas.

23. The apparatus of claim 22 that pulls data from heterogeneous systems at data providers in either real time or via batch mode, via an agent hosted at a data provider or another location, with authentication managed either at each heterogeneous system, each provider, or centrally via some form of encrypted token to prove that a user has proven that he or she is entitled to see medical information and records with specific identifying information even though the user has never authenticated himself or herself to the system housing the information, nor to any other systems belonging to the provider housing the information.

24. The apparatus of claim 23 that provides an interface for people to direct medical records (including specific records or groups of records), to be transmitted from one party to another, using a human friendly interface such as (drag-and-drop), and then performs the that transfer.

25. The apparatus of claim 24 that allows parties to note retention, archive, or removal times for data records so that other parties can backup data for future use prior to it become less accessible or inaccessible.

26. The apparatus of claim 21 that allows providers not yet using Electronic Medical Records systems that can use the aforementioned methods—and patients of these providers—to benefit by having electronic requests converted to email, fax, voice, or other forms which they can receive with their responses optionally converted to digital formats.

27. The apparatus of claim 21 that allows non-providers, or non-providers acting as providers, to act as authorized parties to obtain information and collaborate, and/or in which non-medical-providers are allowed to add notes to medical information for purpose of improving knowledge and performance, and/or in which multiple providers whose having a relationship with the same user (e.g., patient) are allowed to create a de-factor group—if the user so allows—so as to achieve simultaneous sharing of information with multiple physicians and/or other providers and facilitates communication amongst them about the patient.

28. The apparatus of claim 22 that indexes data from heterogeneous databases in multiple locations to improve performance of performing queries on that data.

29. The apparatus of claim 22 that produces advertisements and marketing to people based on medical information that they transmit, have stored, or that they otherwise indicate their interest.

30. The apparatus of claim 23 that decouples of medical testing and test reading exists meaning that medical testing is separated from analyzing and reporting test results so that patients can have tests performed by one provider and the results analyzed (or read) by a provider/providers of their choice, for either a first or subsequent reading.
